(19) United States
(12) Patent Application Publication
(10) Pub. No.: US 2026/0149386 A1
(43) Pub. Date: May 28, 2026

(54) POWER CONVERSION CIRCUIT

(71) Applicant: Murata Manufacturing Co., Ltd., Nagaokakyo-shi (JP)

(72) Inventors: Yuki ISHIKURA, Nagaokakyo-shi (JP); Chinmay BHAGAT, Nagaokakyo-shi (JP)

(73) Assignee: Murata Manufacturing Co., Ltd., Nagaokakyo-shi (JP)

(21) Appl. No.: 19/453,123

(22) Filed: Jan. 20, 2026

Related U.S. Application Data
(63) Continuation of application No. PCT/JP2024/011545, filed on Mar. 25, 2024.

(30) Foreign Application Priority Data
Jul. 21, 2023 (JP) 2023-119286

(51) Int. Cl. H02M 5/458; H02M 1/00; H02M 7/06

(52) U.S. Cl. CPC H02M 5/4585; H02M 1/0054; H02M 7/06

(57) ABSTRACT

A power conversion circuit includes an input node and a transformer having a primary winding and a secondary winding. The primary winding includes a first terminal, a second terminal and a tap between the first and second terminal. A first bidirectional tap-switch (is coupled between the input node and the first terminal of the primary winding. A second bidirectional tap-switch is coupled between the input node and the tap. Control circuitry controls the first bidirectional tap-switch and the second bidirectional tap-switch to selectively connect the input node to either the first terminal or the tap, thereby changing an effective number of turns of the primary winding. This configuration allows the circuit to suppress switching losses when an input voltage amplitude changes.

### CROSS-REFERENCE TO RELATED APPLICATIONS

This application is a continuation of International Application No. PCT/JP2024/011545, filed Mar. 25, 2024, which claims priority to Japanese Patent Application No. 2023-119286, filed Jul. 21, 2023, the entire contents of each of which are hereby incorporated by reference.

### TECHNICAL FIELD

The present disclosure relates to a power conversion circuit.

### BACKGROUND ART

A charging device described in Patent Document 1 includes a non-isolated converter and an isolated converter. The non-isolated converter converts input alternating current (AC) power to direct current (DC) power. The DC power, which is output from the non-isolated converter, is input to the isolated converter. The isolated converter has a transformer. The non-isolated converter has switch devices.

### CITATION LIST

### Patent Document

Patent Document 1: Japanese Unexamined Patent Application Publication No. 2014-53992

### SUMMARY

The present disclosure provides a power conversion circuit including: a transformer that has a primary winding and a secondary winding, the primary winding having a first terminal and a second terminal; an input terminal; a first bidirectional switch that is connected, at a first end thereof, to the input terminal, and that is connected, at a second end thereof, to the first terminal of the primary winding; a second bidirectional switch that has a first end and a second end, and that is connected, at the first end thereof, to the input terminal; and a controller that controls the first bidirectional switch and the second bidirectional switch. The primary winding has a tap between the first terminal and the second terminal of the primary winding. The second end of the second bidirectional switch is connected to the tap.

### BRIEF DESCRIPTION OF DRAWINGS

FIG. 1 is a circuit diagram of a power conversion device.

FIG. 2 is a circuit diagram of a first power conversion circuit.

FIG. 3 is a circuit diagram of a second power conversion circuit.

FIG. 4 is a diagram illustrating wave forms and sectors of three-phase AC power.

FIG. 5 is a space-vector diagram of SVPWM.

FIG. 6 is a space-vector diagram of SVPWM.

FIG. 7 is a sequence chart of a first switching pattern.

FIG. 8 is a sequence chart of a second switching pattern.

FIG. 9 is a sequence chart of a third switching pattern.

FIG. 10 is a sequence chart of a fourth switching pattern.

### DESCRIPTION OF EMBODIMENTS

### Technical Problem

The inventors have observed that in conventional charging devices, such as those described in Patent Document 1, an AC voltage input to the charging device may change. Consequently, to keep the output voltage constant, ON-state and OFF-state periods of switch devices must often be adjusted, or additional converters provided. The inventors have recognized that this approach may result in large switching losses depending on the input voltage. Embodiments herein are directed to suppressing an increase in switching loss when the amplitude of an input voltage changes.

### <One Embodiment of Power Conversion Circuits>

An embodiment of power conversion circuits will be described below. In the drawings, components may be enlarged for illustration to facilitate understanding. The size ratios of components may be different from actual ones or from ones in different drawings.

### (1. About Entire Configuration)

As illustrated in FIG. 1, a power conversion device 10 includes an input-side low-pass filter 20, a first power conversion circuit 30, a second power conversion circuit 40, a rectifier circuit 50, and an output-side low-pass filter 60. The power conversion device 10 also includes three external input terminals (also referred to herein as input nodes) 11 and a pair of external output terminals (also referred to herein as output nodes) 12. The power conversion device 10 is a so-called isolated three-phase AC-DC converter. That is, the power conversion device 10 is capable of converting three-phase AC power, which is input to the external input terminals 11, to DC power for output from the external output terminals 12. The second power conversion circuit 40 described below is interposed on power paths from the external input terminals 11 to the external output terminals 12, resulting in electrical insulation between the external input terminal 11 side and the external output terminal 12 side.

The three external input terminals 11 of the power conversion device 10 are a first external input terminal 11A, a second external input terminal 11B, and a third external input terminal 11C. The external input terminals 11 receive, on a one-to-one basis, the three phases of three-phase AC power received from a three-phase AC power supply 80. The three-phase AC power supply 80 is a commercial three-phase three-wire power system having three Y-connected AC power supplies.

The pair of external output terminals 12 are a first external output terminal 12A and a second external output terminal 12B. Any load 70 may be connected between the first external output terminal 12A and the second external output terminal 12B. The load 70 is, for example, an electronic device driven by DC power.

The input-side low-pass filter 20 includes a first inductor L1, a second inductor L2, and a third inductor L3. The input-side low-pass filter 20 also includes a first capacitor C1, a second capacitor C2, and a third capacitor C3.

The first inductor L1 is connected, at its first end, to the first external input terminal 11A. The first capacitor C1 is connected, at its first end, to the second end of the first inductor L1.

The second inductor L2 is connected, at its first end, to the second external input terminal 11B. The second capacitor C2 is connected, at its first end, to the second end of the second inductor L2. The second capacitor C2 is connected, at its second end, to the second end of the first capacitor C1.

The third inductor L3 is connected, at its first end, to the third external input terminal 11C. The third capacitor C3 is connected, at its first end, to the second end of the third inductor L3. The third capacitor C3 is connected, at its second end, to the second end of the first capacitor C1.

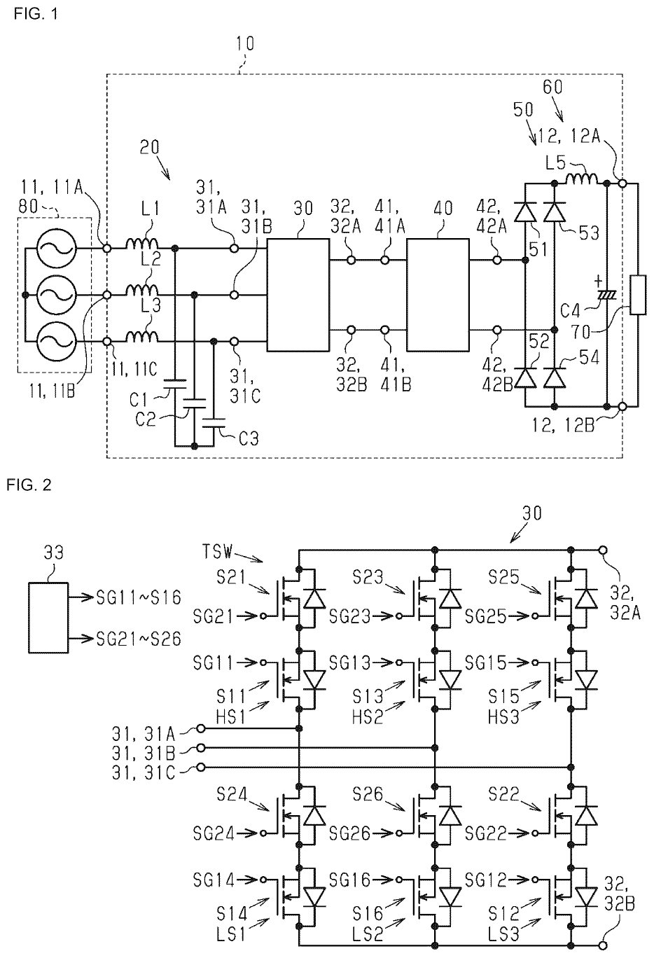

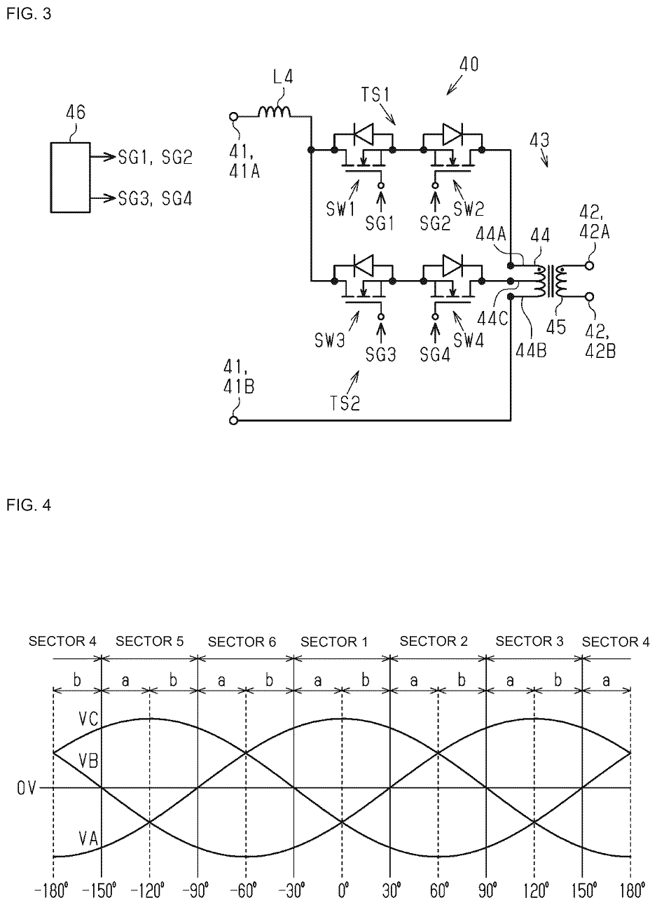

As illustrated in FIG. 2, the first power conversion circuit 30 includes three input connection terminals 31 and a pair of output connection terminals 32. As illustrated in FIG. 3, the first power conversion circuit 30 includes multiple bidirectional switches TSW and a first controller 33.

The first controller 33 (and any other control logic described herein) may be implemented using circuitry or processing circuitry which includes general purpose processors, special purpose processors, integrated circuits, ASICS (“Application Specific Integrated Circuits”), FPGAs (“Field Programmable Gate Arrays”), conventional circuitry and/or combinations thereof which are programmed, using one or more programs stored in one or more memories, or otherwise configured to perform the disclosed functionality. Processors are considered processing circuitry or circuitry as they include transistors and other circuitry therein. The processor may be a programmed processor which executes a program stored in a memory. In the disclosure, the circuitry, units, or means are hardware that carry out or are programmed to perform the recited functionality. The hardware may be any hardware disclosed herein which is programmed or configured to carry out the recited functionality.

As illustrated in FIG. 1, the input connection terminals 31 are a first connection terminal 31A, a second connection terminal 31B, and a third connection terminal 31C. The first connection terminal 31A is connected to the second end of the first inductor L1. The second connection terminal 31B is connected to the second end of the second inductor L2. The third connection terminal 31C is connected to the second end of the third inductor L3. Therefore, the input connection terminals 31 of the first power conversion circuit 30 receive three-phase AC power through the external input terminals 11 and the input-side low-pass filter 20. The pair of output connection terminals 32 are a fourth connection terminal 32A and a fifth connection terminal 32B. High-frequency AC power, which is a conversion result through ON/OFF control on the bidirectional switches TSW, may be output from the pair of output connection terminals 32.

As illustrated in FIG. 2, each bidirectional switch TSW has two switch devices. Each switch device is an N-channel MOSFET (Metal Oxide Semiconductor Field Effect Transistor). That is, each switch device has a body diode. Each bidirectional switch TSW is formed of two switch devices which are connected in series to each other so that the anode terminals of the body diodes are connected to each other. In other words, each bidirectional switch TSW has two switch devices whose source terminals are connected to each other.

The bidirectional switches TSW are a first high-side bidirectional switch HS1, a first low-side bidirectional switch LS1, a second high-side bidirectional switch HS2, a second low-side bidirectional switch LS2, a third high-side bidirectional switch HS3, and a third low-side bidirectional switch LS3.

The first high-side bidirectional switch HS1 connects the first connection terminal 31A and the fourth connection terminal 32A. Specifically, the first high-side bidirectional switch HS1 has an eleventh switch device S11 and a twenty-first switch device S21. The drain terminal of the eleventh switch device S11 is connected to the first connection terminal 31A. The source terminal of the twenty-first switch device S21 is connected to that of the eleventh switch device S11. The drain terminal of the twenty-first switch device S21 is connected to the fourth connection terminal 32A.

The first low-side bidirectional switch LS1 connects the first connection terminal 31A and the fifth connection terminal 32B. Specifically, the first low-side bidirectional switch LS1 has a twenty-fourth switch device S24 and a fourteenth switch device S14. The drain terminal of the twenty-fourth switch device S24 is connected to the first connection terminal 31A. The source terminal of the fourteenth switch device S14 is connected to that of the twenty-fourth switch device S24. The drain terminal of the fourteenth switch device S14 is connected to the fifth connection terminal 32B.

The second high-side bidirectional switch HS2 connects the second connection terminal 31B and the fourth connection terminal 32A. Specifically, the second high-side bidirectional switch HS2 has a thirteenth switch device S13 and a twenty-third switch device S23. The drain terminal of the thirteenth switch device S13 is connected to the second connection terminal 31B. The source terminal of the twenty-third switch device S23 is connected to that of the thirteenth switch device S13. The drain terminal of the twenty-third switch device S23 is connected to the fourth connection terminal 32A.

The second low-side bidirectional switch LS2 connects the second connection terminal 31B and the fifth connection terminal 32B. Specifically, the second low-side bidirectional switch LS2 has a twenty-sixth switch device S26 and a sixteenth switch device S16. The drain terminal of the twenty-sixth switch device S26 is connected to the second connection terminal 31B. The source terminal of the twenty-sixth switch device S26 is connected to that of the sixteenth switch device S16. The drain terminal of the sixteenth switch device S16 is connected to the fifth connection terminal 32B.

The third high-side bidirectional switch HS3 connects the third connection terminal 31C and the fourth connection terminal 32A. Specifically, the third high-side bidirectional switch HS3 has a fifteenth switch device S15 and a twenty-fifth switch device S25. The drain terminal of the fifteenth switch device S15 is connected to the third connection terminal 31C. The source terminal of the twenty-fifth switch device S25 is connected to that of the fifteenth switch device S15. The drain terminal of the twenty-fifth switch device S25 is connected to the fourth connection terminal 32A.

The third low-side bidirectional switch LS3 connects the third connection terminal 31C and the fifth connection terminal 32B. Specifically, the third low-side bidirectional switch LS3 has a twenty-second switch device S22 and a twelfth switch device S12. The drain terminal of the twenty-second switch device S22 is connected to the third connection terminal 31C. The source terminal of the twelfth switch device S12 is connected to that of the twenty-second switch device S22. The drain terminal of the twelfth switch device S12 is connected to the fifth connection terminal 32B.

The first controller 33 controls the bidirectional switches TSW. Specifically, the first controller 33 performs ON/OFF control on the two switch devices, which are included in each bidirectional switch TSW, by inputting switching signals to the gate terminals of the switch devices. The switching signals include an eleventh switching signal SG11 to a sixteenth switching signal SG16 and a twenty-first switching signal SG21 to a twenty-sixth switching signal SG26. The eleventh switching signal SG11 to the sixteenth switching signal SG16 correspond, on a one-to-one basis, to the eleventh switch device S11 to the sixteenth switch device S16. The twenty-first switching signal SG21 to the twenty-sixth switching signal SG26 correspond, on a one-to-one basis, to the twenty-first switch device S21 to the twenty-sixth switch device S26.

Each bidirectional switch TSW may have four ON/OFF states in accordance with combinations of ON and OFF of the switch devices. A description will be made below by taking, as an example, the first high-side bidirectional switch HS1 and the first low-side bidirectional switch LS1.

A first state is the bidirectional ON-state. In the first high-side bidirectional switch HS1, in the case of the bidirectional ON-state, the eleventh switch device S11 is ON, and the twenty-first switch device S21 is ON. In the bidirectional ON-state, the first high-side bidirectional switch HS1 allows a current to flow from the first connection terminal 31A to the fourth connection terminal 32A, and also allows a current to flow from the fourth connection terminal 32A to the first connection terminal 31A.

In the first low-side bidirectional switch LS1, in the case of the bidirectional ON-state, the fourteenth switch device S14 is ON, and the twenty-fourth switch device S24 is ON. In the bidirectional ON-state, the first low-side bidirectional switch LS1 allows a current to flow from the first connection terminal 31A to the fifth connection terminal 32B, and also allows a current to flow from the fifth connection terminal 32B to the first connection terminal 31A.

A second state is the forward ON-state. In the first high-side bidirectional switch HS1, in the case of the forward ON-state, the eleventh switch device S11 is ON, and the twenty-first switch device S21 is OFF. In the forward ON-state, the first high-side bidirectional switch HS1 allows a current to flow from the first connection terminal 31A through the body diode of the twenty-first switch device S21 to the fourth connection terminal 32A. In contrast, the first high-side bidirectional switch HS1 does not allow a current to flow from the fourth connection terminal 32A to the first connection terminal 31A.

In the first low-side bidirectional switch LS1, in the case of the forward ON-state, the fourteenth switch device S14 is ON, and the twenty-fourth switch device S24 is OFF. In the forward ON-state, the first low-side bidirectional switch LS1 allows a current to flow from the fifth connection terminal 32B through the body diode of the twenty-fourth switch device S24 to the first connection terminal 31A. In contrast, the first low-side bidirectional switch LS1 does not allow a current to flow from the first connection terminal 31A to the fifth connection terminal 32B.

A third state is the reverse ON-state. In the first high-side bidirectional switch HS1, in the case of the reverse ON-state, the eleventh switch device S11 is OFF, and the twenty-first switch device S21 is ON. In the reverse ON-state, the first high-side bidirectional switch HS1 allows a current to flow from the fourth connection terminal 32A through the body diode of the eleventh switch device S11 to the first connection terminal 31A. In contrast, the first high-side bidirectional switch HS1 does not allow a current to flow from the first connection terminal 31A to the fourth connection terminal 32A.

In the first low-side bidirectional switch LS1, in the case of the reverse ON-state, the fourteenth switch device S14 is OFF, and the twenty-fourth switch device S24 is ON. In the reverse ON-state, the first low-side bidirectional switch LS1 allows a current to flow from the first connection terminal 31A through the body diode of the fourteenth switch device S14 to the fifth connection terminal 32B. In contrast, the first low-side bidirectional switch LS1 does not allow a current to flow from the fifth connection terminal 32B to the first connection terminal 31A.

A fourth state is the OFF-state. In the first high-side bidirectional switch HS1, in the case of the OFF-state, the eleventh switch device S11 is OFF, and the twenty-first switch device S21 is OFF. In the OFF-state, the first high-side bidirectional switch HS1 allows a current to flow neither from the first connection terminal 31A to the fourth connection terminal 32A, nor from the fourth connection terminal 32A to the first connection terminal 31A.

In the first low-side bidirectional switch LS1, in the case of the OFF-state, the fourteenth switch device S14 is OFF, and the twenty-fourth switch device S24 is OFF. In the OFF-state, the first low-side bidirectional switch LS1 allows a current to flow neither from the first connection terminal 31A to the fifth connection terminal 32B, nor from the fifth connection terminal 32B to the first connection terminal 31A.

As illustrated in FIG. 3, the second power conversion circuit 40 includes a pair of input terminals 41 and a pair of output terminals 42. In addition, the second power conversion circuit 40 includes a fourth inductor L4, a first bidirectional tap-switch TS1 serving as a first bidirectional switch, a second bidirectional tap-switch TS2 serving as a second bidirectional switch, a transformer 43, and a second controller 46.

As illustrated in FIG. 1, the pair of input terminals 41 are a first input terminal 41A and a second input terminal 41B. The first input terminal 41A is connected to the fourth connection terminal 32A. The second input terminal 41B is connected to the fifth connection terminal 32B. The pair of output terminals 42 are a first output terminal 42A and a second output terminal 42B. AC power may be output from the pair of output terminals 42. As illustrated in FIG. 3, the first input terminal 41A is connected to a first end of the fourth inductor L4.

The transformer 43 includes a primary winding 44 and a secondary winding 45. The primary winding 44 has a first terminal 44A, a second terminal 44B, and a tap 44C. The tap 44C is a terminal positioned between the first terminal 44A and the second terminal 44B, for example, at the middle.

The first terminal 44A of the primary winding 44 is connected to the second end of the fourth inductor L4 through the first bidirectional tap-switch TS1. Thus, the first bidirectional tap-switch TS1 is coupled to the first input terminal 41A via the fourth inductor L4. The tap 44C of the primary winding 44 is connected to the second end of the fourth inductor L4 through the second bidirectional tap-switch TS2. The primary winding 44 is connected, at its second end, to the second input terminal 41B.

The secondary winding 45 is connected, at its first end, to the first output terminal 42A. The secondary winding 45 is connected, at its second end, to the second output terminal 42B. As illustrated in FIG. 1, the output terminals 42 are connected to the external output terminals 12 through the rectifier circuit 50 and the output-side low-pass filter 60. The primary winding 44 is electrically insulated from the secondary winding 45.

As illustrated in FIG. 3, each bidirectional tap-switch has two switch devices. Each switch device is a N-channel MOSFET. That is, each switch device has a body diode. Each bidirectional tap-switch is formed of two switch devices which are connected in series to each other so that the anode terminals of the body diodes are connected to each other. In other words, each bidirectional tap-switch has two switch devices whose source terminals are connected to each other.

The first bidirectional tap-switch TS1 has a first switch device SW1 and a second switch device SW2. The drain terminal of the first switch device SW1 is connected to the second end of the fourth inductor L4. The source terminal of the first switch device SW1 is connected to that of the second switch device SW2. The drain terminal of the second switch device SW2 is connected to the first end of the primary winding 44.

The second bidirectional tap-switch TS2 has a third switch device SW3 and a fourth switch device SW4. The drain terminal of the third switch device SW3 is connected to the second end of the fourth inductor L4. The source terminal of the third switch device SW3 is connected to that of the fourth switch device SW4. The drain terminal of the fourth switch device SW4 is connected to the tap 44C of the primary winding 44.

Each bidirectional tap-switch may have four ON/OFF states in accordance with combinations of ON and OFF of the switch devices. A description will be made below by taking, as an example, the first bidirectional tap-switch TS1.

A first state is the bidirectional ON-state. In the case of the bidirectional ON-state, the first switch device SW1 is ON, and the second switch device SW2 is ON. In the bidirectional ON-state, the first bidirectional tap-switch TS1 allows a current to flow from the second end of the fourth inductor L4 to the first terminal 44A of the primary winding 44, and also allows a current to flow from the first terminal 44A of the primary winding 44 to the second end of the fourth inductor L4.

A second state is the forward ON-state. In the forward ON-state, the first switch device SW1 is ON, and the second switch device SW2 is OFF. In the forward ON-state, the first bidirectional tap-switch TS1 allows a current to flow from the second end of the fourth inductor L4 through the body diode of the second switch device SW2 to the first terminal 44A of the primary winding 44. In contrast, the first bidirectional tap-switch TS1 does not allow a current to flow from the first terminal 44A of the primary winding 44 to the second end of the fourth inductor L4.

A third state is the reverse ON-state. In the case of the reverse ON-state, in the first bidirectional tap-switch TS1, the first switch device SW1 is OFF, and the second switch device SW2 is ON. In the reverse ON-state, the first bidirectional tap-switch TS1 allows a current to flow from the first terminal 44A of the primary winding 44 through the body diode of the first switch device SW1 to the second end of the fourth inductor L4. In contrast, the first bidirectional tap-switch TS1 does not allow a current to flow from the second end of the fourth inductor L4 to the first terminal 44A of the primary winding 44 of the transformer 43.

A fourth state is the OFF-state. In the case of the OFF-state, in the first bidirectional tap-switch TS1, the first switch device SW1 is OFF, and the second switch device SW2 is OFF. In the OFF-state, the first bidirectional tap-switch TS1 allows a current to flow neither from the second end of the fourth inductor L4 to the first terminal 44A of the primary winding 44 of the transformer 43, nor from the first terminal 44A of the primary winding 44 to the second end of the fourth inductor L4.

The second controller 46 performs ON/OFF control on the two switch devices, which are included in each bidirectional tap-switch, by inputting switching signals to the gate terminals of the switch devices. Specifically, the second controller 46 inputs a first switching signal SG1 to the gate terminal of the first switch device SW1. The second controller 46 inputs a second switching signal SG2 to the gate terminal of the second switch device SW2. The second controller 46 inputs a third switching signal SG3 to the gate terminal of the third switch device SW3. The second controller 46 inputs a fourth switching signal SG4 to the gate terminal of the fourth switch device SW4.

As illustrated in FIG. 1, the rectifier circuit 50 is a full-wave rectifier circuit formed of four diodes. Specifically, the rectifier circuit 50 includes a first diode 51, a second diode 52, a third diode 53, and a fourth diode 54. The anode terminal of the first diode 51 is connected to the first output terminal 42A of the second power conversion circuit 40. The cathode terminal of the first diode 51 is connected to that of the third diode 53. The anode terminal of the third diode 53 is connected to the second output terminal 42B of the second power conversion circuit 40 and the cathode terminal of the fourth diode 54. The anode terminal of the fourth diode 54 is connected to that of the second diode 52. The cathode terminal of the second diode 52 is connected to the first output terminal 42A of the second power conversion circuit 40 and the anode terminal of the first diode 51.

The cathode terminal of the first diode 51 and that of the third diode 53 are connected to the first external output terminal 12A through the output-side low-pass filter 60. The anode terminal of the second diode 52 and that of the fourth diode 54 are connected to the second external output terminal 12B. Therefore, the first diode 51 allows a current to flow from the first output terminal 42A to the first external output terminal 12A side. The fourth diode 54 allows a current to flow from the second external output terminal 12B to the second output terminal 42B. The third diode 53 allows a current to flow from the second output terminal 42B to the first external output terminal 12A side. The second diode 52 allows a current to flow from the second external output terminal 12B to the first output terminal 42A.

The output-side low-pass filter 60 includes a fifth inductor L5 and a fourth capacitor C4. The fifth inductor L5 is connected, at its first end, to the cathode terminal of the first diode 51 and the cathode terminal of the third diode 53. The fifth inductor L5 is connected, at its second end, to the first external output terminal 12A. The fourth capacitor C4 is connected, at its first end, to the second end of the fifth inductor L5. The fourth capacitor C4 is connected, at its second end, to the second external output terminal 12B.

### (2. About Definition of Sector)

As described above, the first power conversion circuit 30 receives, at the input connection terminals 31, three-phase AC power from the three-phase AC power supply 80 through the external input terminals 11 and the input-side low-pass filter 20. As illustrated in FIG. 4, the three-phase voltages of the three-phase AC power are a first voltage VA, a second voltage VB, and a third voltage VC which are AC voltages having phases different from one another. The first connection terminal 31A, the second connection terminal 31B, and the third connection terminal 31C receive the respective voltages on a one-to-one basis. Specifically, the first connection terminal 31A receives the first voltage VA. The second connection terminal 31B receives the second voltage VB. The third connection terminal 31C receives the third voltage VC. The second voltage VB has a phase difference of 120° with respect to the first voltage VA. The third voltage VC has a phase difference of 120° with respect to the second voltage VB. “A phase difference of 120°” allows an error of about ±1°.

In the description below, the time of the phase at which the first voltage VA reaches its maximum is defined as 0°. The time of the phase at which the first voltage VA reaches its minimum is defined as −180°. Therefore, one cycle of each of the first voltage VA, the second voltage VB, and the third voltage VC is represented as a range of phase between −180°, inclusive, and 180°, exclusive. However, for the sake of convenience, the time of the voltage phase may be expressed by using a phase of 180° or greater. When the voltage phase is represented by using a phase of 180° or greater, X° is synonymous with (−180°+(X−180°)). Sector 1 to sector 6 are defined as periods obtained by equally dividing the period of a single cycle into six sections. Specifically, sector 1 to sector 6 are defined as the following periods at intervals of 60°, where the phase of the first voltage VA is “θ°”.

$$\cdot Sector 1 : - 30 ° \leq θ° < 30 °$$

$$\cdot Sector 2 : 30 ° \leq θ° < 90 °$$

$$\cdot Sector 3 : 90 ° \leq θ° < 150 °$$

$$\cdot Sector 4 : 150 ° \leq θ° < 180 ° and \text{-} 180 ° \leq θ° < - 150 °$$

$$\cdot Sector 5 : - 150 ° \leq θ° < - 90 °$$

$$\cdot Sector 6 : - 90 ° \leq θ° < - 30 °$$

Each of sector 1 to sector 6 is further segmented into two periods. In other words, one cycle of the three-phase AC power is segmented into 12 periods. In the description below, where n, which is an integer greater than or equal to one and less than or equal to six, corresponds to a sector number, sector n is segmented into two periods of sector na and sector nb. In the present embodiment, each period is defined as follows.

$$\cdot Sector na \text{:} ( X ° - 30 ° ) \leq θ° < X °$$

$$\cdot Sector nb \text{:} X ° \leq θ° < ( X ° + 30 ° )$$

The midpoint of the period of sector n is defined as X°. The expression, “the midpoint of a period”, means the midpoint value of the endpoints of each sector represented by a half-open interval. However, in the definition of sector 4a, X=180°.

### (3. About Vector Sequence)

In the description below, the potential difference of the fourth connection terminal 32A with respect to the fifth connection terminal 32B is represented by primary voltage Vp. In other words, the primary voltage Vp is the potential difference of the first input terminal 41A with respect to the second input terminal 41B of the second power conversion circuit 40. A current flowing between the fourth connection terminal 32A and the fifth connection terminal 32B is represented by primary current Ip. In other words, the primary current Ip is a current flowing between the second input terminal 41B and the first input terminal 41A of the second power conversion circuit 40. Specifically, the primary current Ip is a current flowing through the fourth inductor L4, the bidirectional tap-switches, and the primary winding 44 in the second power conversion circuit 40. The direction in which the primary current Ip flows from the first input terminal 41A to the second input terminal 41B is referred to as the forward direction. The direction in which the primary current Ip flows from the second input terminal 41B to the first input terminal 41A is referred to as the reverse direction.

The phase of the first voltage VA is referred to as A-phase; the phase of the second voltage VB is referred to as B-phase; the phase of the third voltage VC is referred to as C-phase; any phase is referred to as i-phase. Among the three phases, a phase different from the i-phase is referred to as j-phase. In the description below, the voltage difference obtained by subtracting the j-phase voltage from the i-phase voltage is described as “line voltage Vij”.

The first controller 33 controls the pulse width of each switching signal by using space vector pulse width modulation (SVPWM).

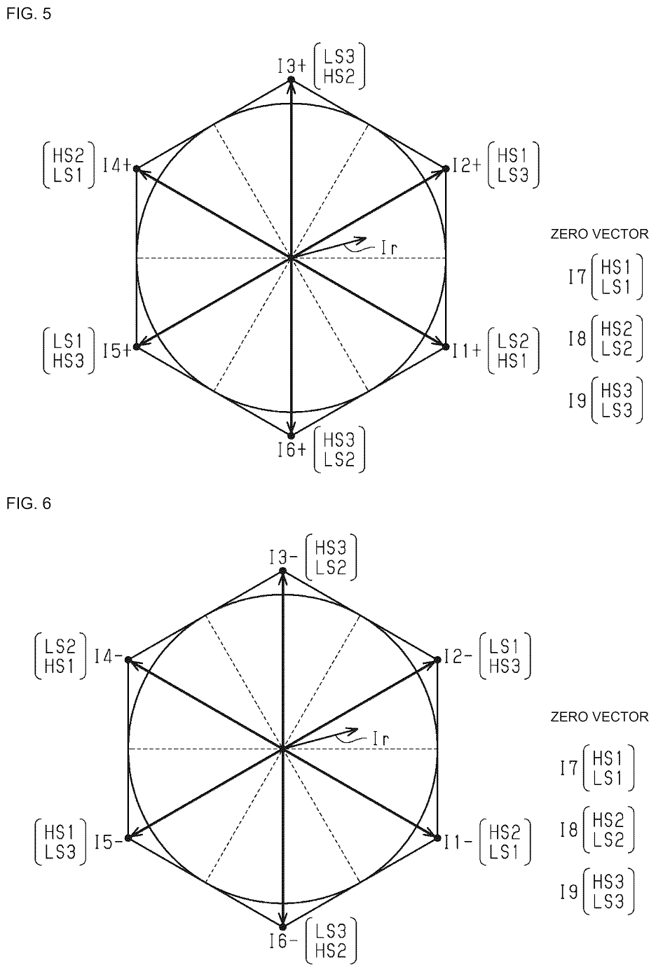

As illustrated in FIGS. 5 and 6, in control using SVPWM, active vectors and zero vectors Iz are defined. In the present embodiment, the active vectors and the zero vectors Iz are current vectors of the first power conversion circuit 30 in predetermined switching states. An active vector is expressed, as a space vector, in the mathematical expression illustrated in Math. 1 described below where m is an integer greater than or equal to one and less than or equal to six. In Math. 1, “I” represents the absolute value of the primary current Ip.

$$\vec{{I}_{m}} = \frac{2}{\sqrt{3}} I \cdot {e}^{j ( \frac{m π}{3} - \frac{π}{2} )} \qquad [ Math . 1 ]$$

The active vectors are broadly categorized into forward active vectors and reverse active vectors.

Specifically, as illustrated in FIG. 5, the forward active vectors include first forward active vector I1+ to sixth forward active vector I6+. Each forward active vector is a current vector obtained when the primary voltage Vp is positive and the bidirectional switches TSW are in the corresponding switching state described below.
The first forward active vector I1+: The second low-side bidirectional switch LS2 is in the bidirectional ON-state or the forward ON-state. In addition, the first high-side bidirectional switch HS1 is in the bidirectional ON-state or the forward ON-state. In this state, the primary voltage Vp is line voltage VAB.
The second forward active vector I2+: The first high-side bidirectional switch HS1 is in the bidirectional ON-state or the forward ON-state. In addition, the third low-side bidirectional switch LS3 is in the bidirectional ON-state or the forward ON-state. In this state, the primary voltage Vp is line voltage VAC.
The third forward active vector I3+: The third low-side bidirectional switch LS3 is in the bidirectional ON-state or the forward ON-state. In addition, the second high-side bidirectional switch HS2 is in the bidirectional ON-state or the forward ON-state. In this state, the primary voltage Vp is line voltage VBC.
The fourth forward active vector I4+: The second high-side bidirectional switch HS2 is in the bidirectional ON-state or the forward ON-state. In addition, the first low-side bidirectional switch LS1 is in the bidirectional ON-state or the forward ON-state. In this state, the primary voltage Vp is line voltage VBA.
The fifth forward active vector I5+: The first low-side bidirectional switch LS1 is in the bidirectional ON-state or the forward ON-state. In addition, the third high-side bidirectional switch HS3 is in the bidirectional ON-state or the forward ON-state. In this state, the primary voltage Vp is line voltage VCA.
The sixth forward active vector I6+: The third high-side bidirectional switch HS3 is in the bidirectional ON-state or the forward ON-state. In addition, the second low-side bidirectional switch LS2 is in the bidirectional ON-state or in the forward ON-state. In this state, the primary voltage Vp is line voltage VCB.

As illustrated in FIG. 6, the reverse active vectors include first reverse active vector I1− to sixth reverse active vector I6−. Each reverse active vector is a current vector obtained when the primary voltage Vp is negative and the bidirectional switches TSW are in the corresponding switching state described below.
The first reverse active vector I1−: The second high-side bidirectional switch HS2 is in the bidirectional ON-state or the reverse ON-state. In addition, the first low-side bidirectional switch LS1 is in the bidirectional ON-state or the reverse ON-state. In this state, the primary voltage Vp is line voltage VAB.
The second reverse active vector I2−: The first low-side bidirectional switch LS1 is in the bidirectional ON-state or the reverse ON-state. In addition, the third high-side bidirectional switch HS3 is in the bidirectional ON-state or the reverse ON-state. In this state, the primary voltage Vp is line voltage VAC.
The third reverse active vector I3−: The third high-side bidirectional switch HS3 is in the bidirectional ON-state or the reverse ON-state. In addition, the second low-side bidirectional switch LS2 is in the bidirectional ON-state or the reverse ON-state. In this state, the primary voltage Vp is line voltage VBC.
The fourth reverse active vector I4−: The second low-side bidirectional switch LS2 is in the bidirectional ON-state or the reverse ON-state. In addition, the first high-side bidirectional switch HS1 is in the bidirectional ON-state or the reverse ON-state. In this state, the primary voltage Vp is line voltage VBA.
The fifth reverse active vector I5−: The first high-side bidirectional switch HS1 is in the bidirectional ON-state or the reverse ON-state. In addition, the third low-side bidirectional switch LS3 is in the bidirectional ON-state or the reverse ON-state. In this state, the primary voltage Vp is line voltage VCA.
The sixth reverse active vector I6−: The third low-side bidirectional switch LS3 is in the bidirectional ON-state or the reverse ON-state. In addition, the second high-side bidirectional switch HS2 is in the bidirectional ON-state or the reverse ON-state. In this state, the primary voltage Vp is line voltage VCB.

As illustrated in FIGS. 5 and 6, the zero vectors Iz include seventh zero vector I7, eighth zero vector I8, and ninth zero vector I9. Each zero vector Iz is a current vector obtained when the primary voltage Vp is zero and the bidirectional switches TSW are in the corresponding switching state described below. “A primary voltage of zero” allows, for example, an error of about ±10 V.
The seventh zero vector I7: The first high-side bidirectional switch HS1 is in the bidirectional ON-state or the forward ON-state, and the first low-side bidirectional switch LS1 is in the bidirectional ON-state or the forward ON-state. Alternatively, the first high-side bidirectional switch HS1 is in the bidirectional ON-state or the reverse ON-state, and the first low-side bidirectional switch LS1 is in the bidirectional ON-state or the reverse ON-state.
The eighth zero vector I8: The second high-side bidirectional switch HS2 is in the bidirectional ON-state or the forward ON-state, and the second low-side bidirectional switch LS2 is in the bidirectional ON-state or the forward ON-state. Alternatively, the second high-side bidirectional switch HS2 is in the bidirectional ON-state or the reverse ON-state, and the second low-side bidirectional switch LS2 is in the bidirectional ON-state or the reverse ON-state.
The ninth zero vector I9: The third high-side bidirectional switch HS3 is in the bidirectional ON-state or the forward ON-state, and the third low-side bidirectional switch LS3 is in the bidirectional ON-state or the forward ON-state. Alternatively, the third high-side bidirectional switch HS3 is in the bidirectional ON-state or the reverse ON-state, and the third low-side bidirectional switch LS3 is in the bidirectional ON-state or the reverse ON-state.

A reference vector Ir of a current in sector n is analogous to a composite vector of active vectors and a zero vector Iz described above. Specifically, the reference vector Ir is analogous as described below, when x=n and y=x+1. However, when x=6, y=1. The reference vector Ir of a current in sector n is analogous to a composite vector of the x-th forward active vector Ix+, the y-th forward active vector Iy+, and a zero vector Iz. Otherwise, the reference vector Ir of a current in sector n is analogous to a composite vector of the x-th reverse active vector Ix−, the y-th reverse active vector Iy−, and a zero vector Iz. The zero vector Iz is the seventh zero vector I7 in sector 1 and sector 4. The zero vector Iz is the ninth zero vector I9 in sector 2 and sector 5. The zero vector Iz is the eighth zero vector I8 in sector 3 and sector 6.

In principle, the first controller 33 performs ON/OFF control on the bidirectional switches TSW so that the reference vector Ir makes transitions among the active vectors and zero vectors Iz in certain order in accordance with the magnitude relationship between the first voltage VA, the second voltage VB, and the third voltage VC.

Specifically, in sector na, the first controller 33 performs ON/OFF control on the bidirectional switches TSW so that the current vector follows a first vector sequence described in (a). In sector nb, the first controller 33 performs ON/OFF control on the bidirectional switches TSW so that the current vector follows a second vector sequence described in (b). (a) The first vector sequence: the order of the x-th forward active vector Ix+, the y-th forward active vector Iy+, a zero vector Iz, the x-th reverse active vector Ix−, and the y-th reverse active vector Iy−, and the zero vector Iz. (b) The second vector sequence: the y-th forward active vector Iy+, the x-th forward active vector Ix+, a zero vector Iz, the y-th reverse active vector Iy−, the x-th reverse active vector Ix−, and the zero vector Iz.

Thus, for example, when n=3, that is, in sector 3a, the first controller 33 performs ON/OFF control on the bidirectional switches TSW so that the reference vector Ir makes transitions in the order of the third forward active vector I3+, the fourth forward active vector I4+, the eighth zero vector I8, the third reverse active vector I3−, the fourth reverse active vector I4−, and the eighth zero vector 18. In sector 3b, the first controller 33 performs ON/OFF control on the bidirectional switches TSW so that the reference vector Ir makes transitions in the order of the fourth forward active vector I4+, the third forward active vector I3+, the eighth zero vector I8, the fourth reverse active vector I4−, the third reverse active vector I3−, and the eighth zero vector I8.

In sector na, the first controller 33 repeatedly performs the ON/OFF control on the bidirectional switches TSW according to the first vector sequence in each certain cycle Ts. The cycle Ts is much shorter than the period of each sector na.

In sector nb, the first controller 33 repeatedly performs the ON/OFF control on the bidirectional switches TSW according to the second vector sequence in each cycle Ts which is the same as that for the first vector sequence. The cycle Ts is much shorter than the period of each sector nb.

### (4. About Switching Control Using Tap)

Switching control which may be performed by the second controller 46 will be described below. Changes of the primary voltage Vp and the primary current Ip in a single cycle Ts for a vector sequence will be described by taking the first vector sequence as an example.

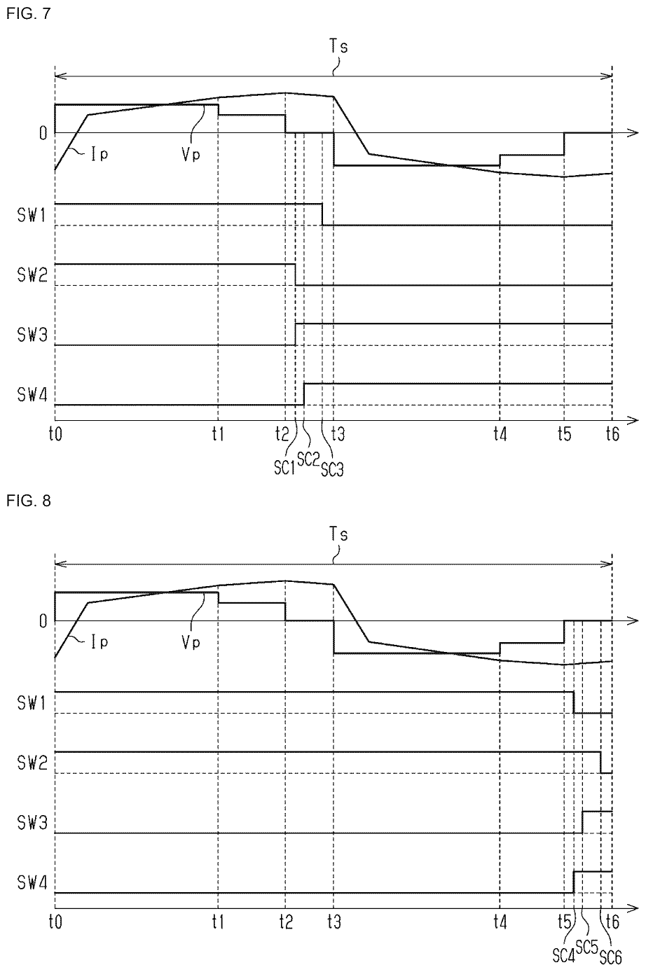

As illustrated in FIGS. 7 to 10, between time to and time t1, the reference vector Ir is the x-th forward active vector Ix+. That is, the primary voltage Vp is positive. In this period, the direction of the primary current Ip changes from the reverse direction to the forward direction.

Between time t1 and time t2, the reference vector Ir is the y-th forward active vector Iy+. That is, the primary voltage Vp is positive. During the period, the direction of the primary current Ip is the forward direction.

Between time t2 and time t3, the reference vector Ir is the zero vector Iz. That is, the primary voltage Vp is approximately zero. During the period, the direction of the primary current Ip is the forward direction.

Between time t3 and time t4, the reference vector Ir is the x-th reverse active vector Ix−. That is, the primary voltage Vp is negative. In the period, the direction of the primary current Ip changes from the forward direction to the reverse direction.

Between time t4 and time t5, the reference vector Ir is the y-th reverse active vector Iy−. That is, the primary voltage Vp is negative. During the period, the direction of the primary current Ip is the reverse direction.

Between time t5 and time t6, the reference vector Ir is the zero vector Iz. That is, the primary voltage Vp is approximately zero. During the period, the direction of the primary current Ip is the reverse direction.

FIG. 10 illustrates the period from time t3 to time t6, and illustrates the period from time to′ to time t3′ in the next cycle of the period. The changes of the primary voltage Vp and the primary current Ip from time to′ to time t3′ are substantially the same as changes of the primary voltage Vp and the primary current Ip from time t0 to time t3.

Also in the case of the second vector sequence, the changes of the primary voltage Vp and the primary current Ip in a single cycle Ts are substantially the same as those of the primary voltage Vp and the primary current Ip in the first vector sequence which are described above.

In a period in which the absolute value of the primary voltage Vp applied between the first terminal 44A and the second terminal 44B of the primary winding 44 is less than or equal to a predetermined threshold, the second controller 46 switches the ON/OFF states of the first bidirectional tap-switch TS1 and the second bidirectional tap-switch TS2. In the present embodiment, the predetermined threshold is 10 V. That is, in a period in which the primary voltage Vp is greater than or equal to −10 V and less than or equal to 10 V, the second controller 46 switches the ON/OFF states of the first bidirectional tap-switch TS1 and the second bidirectional tap-switch TS2. In the description below, a period in which the absolute value of the primary voltage Vp is less than or equal to the threshold is referred to as a “period in which the primary voltage approximately zero”. Specifically, a period in which the primary voltage Vp is approximately zero is a period in which the reference vector Ir is a zero vector Iz, in the vector sequence. That is, such a period corresponds to the period from time t2 to time t3 and the period from time t5 to time t6.

The second controller 46 may perform tap switching control on the first bidirectional tap-switch TS1 and the second bidirectional tap-switch TS2. The tap switching control refers to control for switching between the state, in which the first bidirectional tap-switch TS1 is in the bidirectional ON-state and the second bidirectional tap-switch TS2 is in the OFF-state, and the state, in which the first bidirectional tap-switch TS1 is in the OFF-state and the second bidirectional tap-switch TS2 is in the bidirectional ON-state.

In the switching control by the second controller 46, the combination of the ON-states and the OFF-states of the first switch device SW1, the second switch device SW2, the third switch device SW3, and the fourth switch device SW4 is different between the case in which the primary current Ip flows in the forward direction and the case in which the primary current Ip flows in the reverse direction. That is, in the switching control, the switching pattern for the switch devices, which is performed by the second controller 46, is different depending on the direction of the primary current Ip. Specifically, there are four switching patterns, a first switching pattern to a fourth switching pattern. The first switching pattern to the fourth switching pattern correspond to a first initial state to a fourth initial state of the second power conversion circuit 40. The switching pattern refers to a combination of the ON-states and the OFF-states of the switch devices.

### (4-1. First Switching Pattern)

In a period in which the primary current Ip flows in the forward direction, the second controller 46 may control the bidirectional tap-switches according to the first switching pattern. Specifically, as illustrated in FIG. 7, the second controller 46 controls the bidirectional tap-switches according to the first switching pattern with the state at time t2 regarded as the first initial state. In the description below, three time points in the period from time t2 to time t3 are defined as time SC1, time SC2, and time SC3 in order of proximity to time t2. In the first initial state, the first bidirectional tap-switch TS1 is in the bidirectional ON-state; the second bidirectional tap-switch TS2 is in the OFF-state; and the direction of the primary current Ip is the forward direction.

The first switching pattern is constituted by first control to third control described below. Specifically, at time SC1, the second controller 46 performs the first control for switching, from the first initial state, the second switch device SW2 to the OFF-state and the third switch device SW3 to the ON-state. At time SC2, that is, after the first control, the second controller 46 performs the second control for switching the fourth switch device SW4 to the ON-state. At time SC3, that is, after the second control, the second controller 46 performs the third control for switching the first switch device SW1 to the OFF-state. Therefore, at time t3 when the third control has been completed, the first bidirectional tap-switch TS1 is in the OFF-state, and the second bidirectional tap-switch TS2 is in the bidirectional ON-state.

### (4-2. Second Switching Pattern)

In a period in which the primary current Ip flows in the reverse direction, the second controller 46 may control the bidirectional tap-switches according to the second switching pattern. Specifically, as illustrated in FIG. 8, the second controller 46 controls the bidirectional tap-switches according to the second switching pattern with the state at time t5 regarded as the second initial state. In the description below, three time points in the period from time t5 to time t6 are defined as time SC4, time SC5, and time SC6 in order of proximity to time t5. In the second initial state, the first bidirectional tap-switch TS1 is in the bidirectional ON-state; the second bidirectional tap-switch TS2 is in the OFF-state; and the direction of the primary current Ip is the reverse direction.

The second switching pattern is constituted by first control to third control described below. Specifically, at time SC4, the second controller 46 performs the first control for switching, from the second initial state, the first switch device SW1 to the OFF-state and the fourth switch device SW4 to the ON-state. At time SC5, that is, after the first control, the second controller 46 performs the second control for switching the third switch device SW3 to the ON-state. At time SC6, that is, after the second control, the second controller 46 performs the third control for switching the second switch device SW2 to the OFF-state. Therefore, at time t6 when the third control has been completed, the first bidirectional tap-switch TS1 is in the OFF-state, and the second bidirectional tap-switch TS2 is in the bidirectional ON-state.

The ON/OFF states of the bidirectional tap-switches in the initial states of the first switching pattern and the second switching pattern are the same, and those after the third control operations of the switching patterns are the same. In contrast, the directions of the primary current Ip in the initial states are different from each other. Therefore, the switching pattern in the tap switching control is different between the first switching pattern for the case in which the primary current Ip flows in the forward direction and the second switching pattern for the case in which the primary current Ip flows in the reverse direction.

### (4-3. Third Switching Pattern)

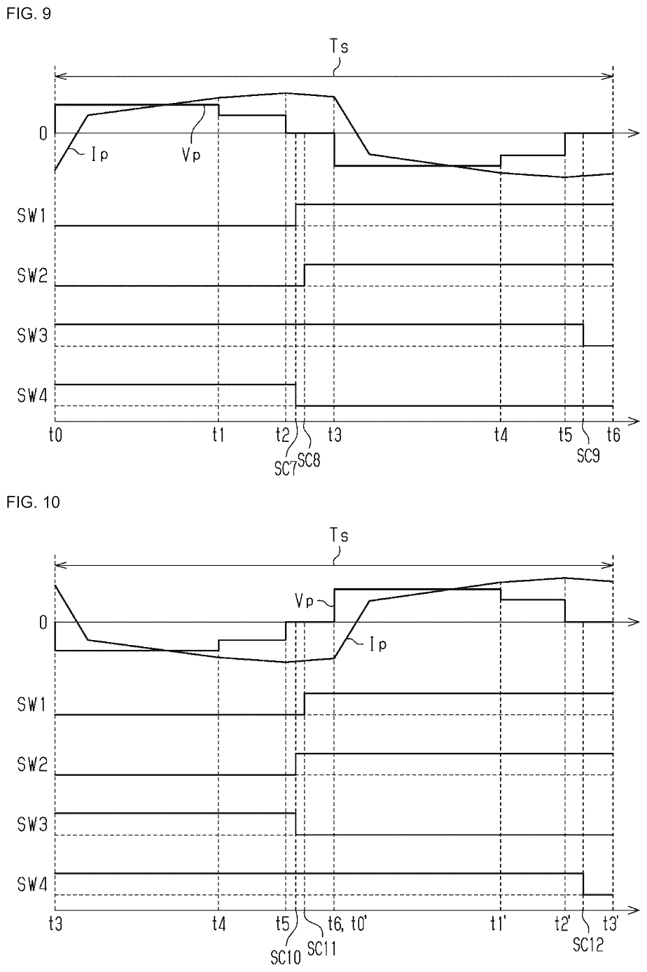

The second controller 46 may control the bidirectional tap-switches according to the third switching pattern. Specifically, as illustrated in FIG. 9, the second controller 46 controls the bidirectional tap-switches according to the third switching pattern with the state at time t2 regarded as the third initial state. In the description below, two time points in the period from time t2 to time t3 are defined as time SC7 and time SC8 in order of proximity to time t2. A time point in the period from time t5 to time t6 is defined as time SC9. In the third initial state, the first bidirectional tap-switch TS1 is in the OFF-state; the second bidirectional tap-switch TS2 is in the bidirectional ON-state; and the direction of the primary current Ip is the forward direction.

The third switching pattern is constituted by first control to third control described below. Specifically, at time SC7, the second controller 46 performs the first control for switching, from the third initial state, the fourth switch device SW4 to the OFF-state and the first switch device SW1 to the ON-state. At time SC8, that is, after the first control, the second controller 46 performs the second control for switching the second switch device SW2 to the ON-state. At time SC9, that is, after the second control, the second controller 46 performs the third control for switching the third switch device SW3 to the OFF-state. Therefore, in the fourth switching pattern, the second controller 46 performs the first control and the second control in a period in which the primary current Ip flows in the forward direction, and performs the third control in a period in which the primary current Ip flows in the reverse direction. At time t3 when the third control has been completed, the first bidirectional tap-switch TS1 is in the OFF-state, and the second bidirectional tap-switch TS2 is in the bidirectional ON-state.

### (4-4. Fourth Switching Pattern)

In a period in which the primary current Ip flows in the reverse direction, the second controller 46 may control the bidirectional tap-switches according to the fourth switching pattern. Specifically, as illustrated in FIG. 10, the second controller 46 controls the bidirectional tap-switches according to the fourth switching pattern with the state at time t5 regarded as the fourth initial state. In the description below, two time points in the period from time t5 to time t6 are defined as time SC10 and time SC11 in order of proximity to time t5. A time point in the period from time t2′ to time t3′ is defined as time SC12. In the fourth initial state, the first bidirectional tap-switch TS1 is in the OFF-state; the second bidirectional tap-switch TS2 is in the bidirectional ON-state; and the direction of the primary current Ip is the reverse direction.

The fourth switching pattern is constituted by first control to third control described below. Specifically, at time SC10, the second controller 46 performs the first control for switching, from the fourth initial state, the third switch device SW3 to the OFF-state and the second switch device SW2 to the ON-state. At time SC11, that is, after the first control, the second controller 46 performs the second control for switching the first switch device SW1 to the ON-state. At time SC12, that is, after the second control, the second controller 46 performs the third control for switching the fourth switch device SW4 to the OFF-state. Therefore, in the fourth switching pattern, the second controller 46 performs the first control and the second control in a period in which the primary current Ip flows in the reverse direction, and performs the third control in a period in which the primary current Ip flows in the forward direction. At time t3 when the third control has been completed, the first bidirectional tap-switch TS1 is in the OFF-state, and the second bidirectional tap-switch TS2 is in the bidirectional ON-state.

The ON/OFF states of the bidirectional tap-switches in the initial states of the third switching pattern and the fourth switching pattern are the same, and those after the third control operations of the switching patterns are the same. In contrast, the directions of the primary current Ip in the initial states are different from each other. Therefore, the switching pattern in the tap switching control is different between the third switching pattern for the case in which the primary current Ip flows in the forward direction and the fourth switching pattern for the case in which the primary current Ip flows in the reverse direction.

### (5. About Effects of Present Embodiment)

(1) In the embodiment, the primary winding 44 of the transformer 43 has the tap 44C. The tap 44C is connected to an input terminal 41 through the second bidirectional tap-switch TS2, enabling the effective ratio of turns of the transformer 43 to be changed. Thus, a change in the magnitude of the input voltage may be also accommodated by changing the effective number of turns of the transformer 43. As a result, an increase in switching loss and that in conduction loss may be suppressed compared with the case in which a change in the magnitude of the input voltage is accommodated by adjusting the ON-state periods and the OFF-state periods of the switch devices in the first power conversion circuit 30, or the case in which an additional converter for adjusting a voltage is provided on the output terminal 42 side of the second power conversion circuit 40.

(2) In the embodiment, ON/OFF control on the bidirectional tap-switches is performed in periods in which the primary voltage Vp is approximately zero. ON/OFF control in a period in which a voltage is applied to the bidirectional tap-switches may cause application of an overvoltage or flowing of an overcurrent to occur in the switch devices included in the bidirectional tap-switches. Therefore, ON/OFF control in periods in which the primary voltage Vp is approximately zero may prevent failure of switch devices caused by the overvoltage and the overcurrent, and achieves a reduction in switching loss.

(3) In the embodiment, each bidirectional tap-switch is formed of two MOSFETs. This enables relatively high-speed switching. In addition, since power loss is relatively low, MOSFETs may be used as switch devices forming a bidirectional tap-switch.

(4) In the embodiment, the second controller 46 may control the bidirectional tap-switches according to the first switching pattern. In the first switching pattern, at time SC1, the voltage applied between the drain terminal and the source terminal of the third switch device SW3 is approximately zero. That is, the first control is so-called zero-voltage switching. At time SC2, the voltage applied between the drain terminal and the source terminal of the fourth switch device SW4 is approximately zero. That is, the second control is also zero-voltage switching. At time SC3, approximately no current flows between the drain terminal and the source terminal of the first switch device SW1. That is, the third control is zero-current switching. In these soft switching operations, approximately no switching loss occurs. In addition, since loads on the switch devices in the ON/OFF switching are light, the probability of failure of the switch devices is low.

In the first switching pattern, the first control to the third control are performed in a period in which the primary current Ip flows in the forward direction. For example, assume the case in which the primary current Ip flows in the reverse direction without execution of the third control after the second control. In this case, a current may flow between the first terminal 44A and the tap 44C of the primary winding 44 through the bidirectional tap-switches. That is, a current may flow along an unintentional path in the primary winding 44. Therefore, according to the present embodiment, occurrence of such a current flowing along an unintentional path may be suppressed.

(5) In the embodiment, the second controller 46 may control the bidirectional tap-switches according to the second switching pattern. In the second switching pattern, the first control and the second control are zero-voltage switching. The third control is zero-current switching. Therefore, even in the second initial state, the second controller 46 may switch the ON/OFF states of the bidirectional tap-switches through soft switching.

In the second switching pattern, the first control to the third control are performed in a period in which the primary current Ip flows in the reverse direction. For example, assume the case in which the primary current Ip flows in the forward direction without execution of the third control after the second control. In this case, a current may flow between the first terminal 44A and the tap 44C of the primary winding 44 through the bidirectional tap-switches. That is, a current may flow along an unintentional path in the primary winding 44. Therefore, according to the present embodiment, occurrence of such a current flowing along an unintentional path may be suppressed.

(6) In the embodiment, the second controller 46 may control the bidirectional tap-switches according to the third switching pattern. In the third switching pattern, the first control and the second control are zero-voltage switching. Therefore, even in the third initial state, the second controller 46 may switch the ON/OFF states of the bidirectional tap-switches. Compared with the case in which control according to the third switching pattern is not performed, the switching loss of the first switch device SW1 and the second switch device SW2 may be made small.

(7) In the embodiment, in the third switching pattern, the second controller 46 may perform the third control in a period in which the primary current Ip flows in the reverse direction. After the second control in the third switching pattern and at a time point when the primary current Ip flows in the reverse direction in the same cycle, no current flows through the second bidirectional tap-switch TS2. That is, the third control is zero-current switching. Therefore, the third control is performed in a period in which the primary current Ip flows in the reverse direction, achieving a small switching loss. In addition, the probability of failure of the switch device may be decreased.

(8) In the embodiment, the second controller 46 may control the bidirectional tap-switches according to the fourth switching pattern. In the fourth switching pattern, the first control and the second control are zero-voltage switching. Therefore, even in the fourth initial state, the second controller 46 may switch the ON/OFF states of the bidirectional tap-switches. Compared with the case in which control according to the fourth switching pattern is not performed, the switching loss of the first switch device SW1 and the second switch device SW2 may be made small.

(9) In the embodiment, in the fourth switching pattern, the second controller 46 may perform the third control in a period in which the primary current Ip flows in the forward direction. After the second control in the fourth switching pattern and at a time point when the primary current Ip flows in the forward direction in the next cycle, no current flows through the second bidirectional tap-switch TS2. That is, the third control is zero-current switching. Therefore, the third control is performed in a period in which the primary current Ip flows in the forward direction, achieving a small switching loss. In addition, the probability of failure of the switch device may be decreased.

(10) In the embodiment, the primary winding 44, not the secondary winding 45, has the tap 44C. A secondary voltage occurring in the secondary winding 45 occurs due to electromagnetic induction of the transformer 43. The phase of the secondary voltage delays relative to those of the input voltage and the primary voltage Vp. Therefore, if the secondary winding 45 has a tap and a switch for switching the ratio of turns, the time at which the switch is to be switched is relatively difficult to be synchronized with the input voltage. Therefore, the primary winding 44 having the tap 44C easily causes soft switching to be performed in synchronization with a change in the input voltage in switching control.

The magnitude of a current flowing through the secondary winding 45 may be larger than that flowing through the primary winding 44. Assume the case in which, in the state in which a current flows through a switch device included in any bidirectional tap-switch, the switch device is switched to the OFF-state. In this case, as a current flowing through the switch becomes larger, the switching loss becomes larger, and the probability of failure of the switch becomes higher. Therefore, the primary winding 44 having the tap 44C may suppress an increase in switching loss. In addition, the probability of failure of the switch may be decreased.

### Modified Examples

The embodiment and modified examples described below may be carried out by combining one another in a range without technical contradiction.

### (About Modified Examples of Power Conversion Device)

The configuration of the power conversion device 10 is not limited to the example according to the embodiment. For example, the power conversion device 10 does not necessarily include one or more selected from the input-side low-pass filter 20, the first power conversion circuit 30, the rectifier circuit 50, and the output-side low-pass filter 60.
The three-phase AC power supply 80 connected to the three external input terminals 11 is not limited to a three-phase three-wire type, and may be a three-phase four-wire type or a delta-connected three-phase AC power supply 80 of three-phase three-wire type. The configuration of the power conversion device 10 may be appropriately changed in accordance with the type of the three-phase AC power supply 80.
In the case of a delta-connected three-phase AC power supply 80, instead of the input-side low-pass filter 20, multiple capacitors connected between lines for the phases which receive the first voltage VA, the second voltage VB, and the third voltage VC may be included.
The configuration of the first controller 33, which is included in the first power conversion circuit 30, and the second controller 46, which is included in the second power conversion circuit 40, is not limited to one in which they are formed as different chips. That is, the second controller 46 may output the eleventh switching signal SG11 to the sixteenth switching signal SG16 and the twenty-first switching signal SG21 to the twenty-sixth switching signal SG26. In any configuration of each controller, a control circuit which may output the first switching signal SG1 to the fourth switching signal SG4 may be regarded as the second controller 46 included in the second power conversion circuit 40.
The switch devices included in the first bidirectional tap-switch TS1 are not limited to the example according to the embodiment. For example, the two switch devices included in each bidirectional switch TSW may be P-channel MOSFETs. In this case, in each bidirectional switch TSW, the drain terminals of the two switch devices are connected to each other. At this point, the same is true for the second bidirectional tap-switch TS2 and the bidirectional switches TSW included in the first power conversion circuit 30.
The two switch devices included in each of the first bidirectional tap-switch TS1 and the second bidirectional tap-switch TS2 may be transistors which allow a current to flow in the forward direction and allow a current to flow in the reverse direction. In this case, the two switch devices are connected in series to each other so that the source terminals are connected to each other. Specifically, the switch devices are, for example, GaN-high electron mobility transistors (GaN-HEMTs). More specifically, the first bidirectional tap-switch TS1 may include the first switch device SW1, whose drain terminal is connected to the first input terminal 41A, and the second switch device SW2, whose drain terminal is connected to the first terminal 44A of the primary winding 44 and whose source terminal is connected to that of the first switch device SW1. The second bidirectional tap-switch TS2 may include the third switch device SW3, whose drain terminal is connected to the first input terminal 41A, and the fourth switch device SW4, whose drain terminal is connected to the tap 44C of the primary winding 44 and whose source terminal is connected to that of the third switch device SW3.

With respect to the point in which a switch device is not limited to a MOSFET, the same is true for the bidirectional switches TSW included in the first power conversion circuit 30.
The second power conversion circuit 40 does not necessarily include the fourth inductor L4. In this case, instead of the fourth inductor L4, leak inductance of the transformer 43 may be used for resonance.
The configuration of the tap 44C included in the primary winding 44 is not limited to the example according to the embodiment. For example, the tap 44C is not necessarily positioned at the middle of the primary winding 44 as long as it is positioned between the first terminal 44A and the second terminal 44B. In addition, the primary winding 44 may have two or more terminals substantially the same as the tap 44C. The second power conversion circuit 40 may have bidirectional tap-switches corresponding to the taps 44C.
When the primary winding 44 has two or more taps 44C, for example, in addition to the configuration of the second power conversion circuit 40 according to the embodiment, the following configuration may be employed. The tap 44C in the second power conversion circuit 40 according to the embodiment is referred to as a first tap. The primary winding has a second tap between the first tap and the second terminal of the primary winding. The power conversion circuit includes a third bidirectional tap-switch which is connected, at its first end, to the first input terminal, and which is connected, at its second end, to the second tap of the primary winding. In this case, the second controller may perform switching control according to the embodiment on two bidirectional tap-switches, among the first to third bidirectional tap-switches, which are a bidirectional tap-switch that is to be switched to the bidirectional ON-state and a bidirectional tap-switch that is to be switched to the OFF-state.
The specific circuit configuration of the rectifier circuit 50 is not limited to the example according to the embodiment. For example, the rectifier circuit 50 may be, for example, a half-wave rectifier circuit.

In the embodiment, among the three input terminals 41 included in the second power conversion circuit 40, which input terminal 41 corresponds to which terminal among the first connection terminal 31A, the second connection terminal 31B, and the third connection terminal 31C may be appropriately changed.

### (About Modified Examples of Switching Control on Tap).

The second controller 46 does not necessarily switch the ON/OFF states of the first bidirectional tap-switch TS1 and the second bidirectional tap-switch TS2 in a period in which the absolute value of the primary voltage Vp is less than or equal to the predetermined threshold. The range is not necessarily a period in which the primary voltage Vp is approximately zero, or is not necessarily determined. Also in this case, the tap 44C included in the primary winding 44 achieves at least the effect described in (1), if the effective ratio of turns of the transformer 43 may be changed.

When whether the absolute value of the primary voltage Vp is less than or equal to the predetermined threshold is to be determined, the second controller 46 does not necessarily calculate the absolute value of the primary voltage Vp, if the absolute value of the primary voltage Vp is substantially less than or equal to the predetermined threshold. For example, the second controller 46 may switch the ON/OFF states of the bidirectional tap-switches in a period in which the primary voltage Vp falls in the predetermined value range including zero. The predetermined value range is, for example, greater than or equal to-10 V and less than or equal to 10 V.
Any configuration may be employed as long as the second controller 46 may perform any of the first switching pattern to the fourth switching pattern. In addition, in switching control on the tap, the switching pattern may be the same between the case in which the primary current Ip flows in the forward direction and the case in which the primary current Ip flows in the reverse direction.
The second controller 46 does not necessarily perform switching control according to the first switching pattern to the fourth switching pattern. Any configuration may be employed as long as switching control for switching the ON/OFF states of the first bidirectional tap-switch TS1 and the second bidirectional tap-switch TS2 may be performed according to any switching pattern. Even when soft switching is not performed, if the tap 44C included in the primary winding 44 enables the effective ratio of turns of the transformer 43 to be changed, this achieves at least the effect described in (1).
In the third switching pattern, the third control is not necessarily performed in a period in which the primary current Ip flows in the reverse direction. Also in this case, the first control and the second control are performed in a period in which the primary current Ip flows in the forward direction, achieving a small switching loss of the first switch device SW1 and the second switch device SW2.
In the fourth switching pattern, the third control is not necessarily performed in a period in which the primary current Ip flows in the forward direction. Also in this case, the first control and the second control are performed in a period in which the primary current Ip flows in the reverse direction, achieving a small switching loss of the first switch device SW1 and the second switch device SW2.

### Appendix

The technical idea introduced from the embodiment and the modified examples will be described below.

[1]

A power conversion circuit comprising:
a transformer that has a primary winding and a secondary winding, the primary winding having a first terminal and a second terminal;
an input terminal;
a first bidirectional switch that is connected, at a first end thereof, to the input terminal, and that is connected, at a second end thereof, to the first terminal of the primary winding;
a second bidirectional switch that has a first end and a second end, and that is connected, at the first end thereof, to the input terminal; and
a controller that controls the first bidirectional switch and the second bidirectional switch,
wherein the primary winding has a tap between the first terminal and the second terminal of the primary winding, and
wherein the second end of the second bidirectional switch is connected to the tap.
   [2]

The power conversion circuit according to [1],
wherein the controller switches ON/OFF states of the first bidirectional switch and the second bidirectional switch in a period in which an absolute value of a voltage applied between the first terminal and the second terminal of the primary winding is less than or equal to a predetermined threshold.
   [3]

The power conversion circuit according to [1] or [2],
wherein the first bidirectional switch has a first switch device and a second switch device, the first switch device having a body diode whose cathode-side terminal is connected to the input terminal, the second switch device having a body diode whose cathode-side terminal is connected to the first terminal of the primary winding, the body diode of the first switch device having an anode-side terminal connected to an anode-side terminal of the body diode of the second switch device,
wherein the second bidirectional switch has a third switch device and a fourth switch device, the third switch device having a body diode whose cathode-side terminal is connected to the input terminal, the fourth switch device having a body diode whose cathode-side terminal connected to the tap of the primary winding, the body diode of the third switch device having an anode-side terminal connected to an anode-side terminal of the body diode of the fourth switch device, and
wherein the controller controls the first bidirectional switch by performing ON/OFF control on the first switch device and the second switch device, and controls the second bidirectional switch by performing control on the third switch device and the fourth switch device.
   [4]

The power conversion circuit according to [3],
wherein the controller is capable of performing switching control for switching from a first state to a second state, the first state being a state in which both the first switch device and the second switch device are in an ON-state and in which both the third switch device and the fourth switch device are in an OFF-state, the second state being a state in which both the first switch device and the second switch device are in the OFF-state and in which both the third switch device and the fourth switch device are in the ON-state, and
wherein, in the switching control, the controller performs control so as to make a combination of the ON-states and the OFF-states of the first switch device, the second switch device, the third switch device, and the fourth switch device different between a first case and a second case, the first case being a case in which a current flows from the first terminal side to the second terminal side in the primary winding, the second case being a case in which a current flows from the second terminal side to the first terminal side.
   [5]

The power conversion circuit according to [3] or [4],
wherein, when an initial state is a state in which both the first switch device and the second switch device are in an ON-state, both the third switch device and the fourth switch device are in an OFF-state, and a current flows from the first terminal to the second terminal of the primary winding,
in a period in which a current flows from the first terminal side to the second terminal side of the primary winding, the controller is capable of performing,
   in the initial state, first control for switching, from the initial state, the second switch device to the OFF-state and the third switch device to the ON-state,
   second control for switching the fourth switch device to the ON-state after the first control, and
   third control for switching the first switch device to the OFF-state after the second control.
      [6]

The power conversion circuit according to any one of [3] to [5],
wherein, when an initial state is a state in which both the first switch device and the second switch device are in an ON-state, both the third switch device and the fourth switch device are in an OFF-state, and a current flows from the second terminal to the first terminal of the primary winding,
in a period in which a current flows from the second terminal side to the first terminal side of the primary winding, the controller is capable of performing,
   in the initial state, first control for switching, from the initial state, the first switch device to the OFF-state and the fourth switch device to the ON-state,
   second control for switching the third switch device to the ON-state after the first control, and
   third control for switching the second switch device to the OFF-state after the second control.
      [7]

The power conversion circuit according to any one of [3] to [6],
wherein, when an initial state is a state in which both the third switch device and the fourth switch device are in an ON-state, both the first switch device and the second switch device are in an OFF-state, and a current flows from the tap to the second terminal of the primary winding,
in a period in which a current flows from the first terminal side to the second terminal side of the primary winding, the controller is capable of performing,
   in the initial state, first control for switching, from the initial state, the fourth switch device to the OFF-state and the first switch device to the ON-state, and
   second control for switching the second switch device to the ON-state after the first control, and
the controller is capable of performing
   third control for switching the third switch device to the OFF-state after the second control.
      [8]

The power conversion circuit according to [7],
wherein the controller performs the third control in a state in which a current flows from the second terminal to the first terminal of the primary winding.
   [9]

The power conversion circuit according to any one of [3] to [8],
wherein, when an initial state is a state in which both the third switch device and the fourth switch device are in an ON-state, both the first switch device and the second switch device are in an OFF-state, and a current flows from the second terminal to the tap of the primary winding,
in a period in which a current flows from the second terminal side to the first terminal side of the primary winding, the controller is capable of performing,
   in the initial state, first control for switching, from the initial state, the third switch device to the OFF-state and the second switch device to the ON-state, and
   second control for switching the first switch device to the ON-state after the first control, and
the controller is capable of performing
   third control for switching the fourth switch device to the OFF-state after the second control.

The power conversion circuit according to [9],
wherein the controller performs the third control in a state in which a current flows from the first terminal to the second terminal of the primary winding.

The power conversion circuit according to [1] or [2],
wherein the first bidirectional switch has a first switch device and a second switch device, the first switch device having a drain terminal connected to the input terminal, the second switch device having a drain terminal connected to the first terminal of the primary winding and having a source terminal connected to a source terminal of the first switch device,
wherein the second bidirectional switch has a third switch device and a fourth switch device, the third switch device having a drain terminal connected to the input terminal, the fourth switch device having a drain terminal connected to the tap of the primary winding and having a source terminal connected to a source terminal of the third switch device,
wherein the first switch device, the second switch device, the third switch device, and the fourth switch device are transistors which are capable of flowing a current in a forward direction and which are capable of flowing a current in a reverse direction, and
wherein the controller controls the first bidirectional switch by performing ON/OFF control on the first switch device and the second switch device, and controls the second bidirectional switch by performing control on the third switch device and the fourth switch device.

### REFERENCE SIGNS LIST

10 power conversion device
40 second power conversion circuit
41A first input terminal
41B second input terminal
42A first output terminal
42B second output terminal
43 transformer
44 primary winding
44A first terminal
44B second terminal
44C tap
45 secondary winding
46 second controller
TS1 first bidirectional tap-switch
SW1 first switch device
SW2 second switch device
TS2 second bidirectional tap-switch
SW3 third switch device
SW4 fourth switch device

1. A power conversion circuit comprising:
a transformer including a primary winding and a secondary winding, the primary winding having a first terminal, a second terminal, and a tap;
an input node;
a first bidirectional switch coupled between the input node and the first terminal of the primary winding;
a second bidirectional switch between the input node and the tap; and
control circuitry configured to control the first bidirectional switch and the second bidirectional switch.

2. The power conversion circuit according to claim 1,
wherein the control circuitry is configured to switch ON/OFF states of the first bidirectional switch and the second bidirectional switch during a period in which an absolute value of a voltage applied between the first terminal and the second terminal of the primary winding is less than or equal to a predetermined threshold.

3. The power conversion circuit according to claim 1,
wherein the first bidirectional switch includes a first switch device and a second switch device, the first switch device including a body diode whose cathode-side terminal is connected to the input terminal, the second switch device including a body diode whose cathode-side terminal is connected to the first terminal of the primary winding, the body diode of the first switch device having an anode-side terminal connected to an anode-side terminal of the body diode of the second switch device,
wherein the second bidirectional switch includes a third switch device and a fourth switch device, the third switch device including a body diode whose cathode-side terminal is connected to the input terminal, the fourth switch device including a body diode whose cathode-side terminal connected to the tap of the primary winding, the body diode of the third switch device having an anode-side terminal connected to an anode-side terminal of the body diode of the fourth switch device, and
wherein the control circuitry is configured to control the first bidirectional switch by performing ON/OFF control on the first switch device and the second switch device, and control the second bidirectional switch by performing control on the third switch device and the fourth switch device.

4. The power conversion circuit according to claim 3,
wherein the control circuitry is configured to perform switching control for switching from a first state to a second state, the first state being a state in which both the first switch device and the second switch device are in an ON-state and in which both the third switch device and the fourth switch device are in an OFF-state, the second state being a state in which both the first switch device and the second switch device are in the OFF-state and in which both the third switch device and the fourth switch device are in the ON-state, and
wherein, in the switching control, the control circuitry is configured to perform control so as to make a combination of the ON-states and the OFF-states of the first switch device, the second switch device, the third switch device, and the fourth switch device different between a first case and a second case, the first case being a case in which a current flows from the first terminal side to the second terminal side in the primary winding, the second case being a case in which a current flows from the second terminal side to the first terminal side.

5. The power conversion circuit according to claim 3,
wherein, when an initial state is a state in which both the first switch device and the second switch device are in an ON-state, both the third switch device and the fourth switch device are in an OFF-state, and a current flows from the first terminal to the second terminal of the primary winding,
in a period in which a current flows from the first terminal side to the second terminal side of the primary winding, the control circuitry is configured to
perform first control to switch, from the initial state, the second switch device to the OFF-state and the third switch device to the ON-state,
perform second control to switch the fourth switch device to the ON-state after the first control, and
perform third control to switch the first switch device to the OFF-state after the second control.

6. The power conversion circuit according to claim 3,
wherein, when an initial state is a state in which both the first switch device and the second switch device are in an ON-state, both the third switch device and the fourth switch device are in an OFF-state, and a current flows from the second terminal to the first terminal of the primary winding,
the control circuitry is configured to, in a period in which a current flows from the second terminal side to the first terminal side of the primary winding:
perform first control to switch, from the initial state, the first switch device to the OFF-state and the fourth switch device to the ON-state,
perform second control to switch the third switch device to the ON-state after the first control, and
perform third control to switch the second switch device to the OFF-state after the second control.

7. The power conversion circuit according to claim 3,
wherein, when an initial state is a state in which both the third switch device and the fourth switch device are in an ON-state, both the first switch device and the second switch device are in an OFF-state, and a current flows from the tap to the second terminal of the primary winding,
the control circuitry is configured to:
in a period in which a current flows from the first terminal side to the second terminal side of the primary winding,
perform first control to switch, from the initial state, the fourth switch device to the OFF-state and the first switch device to the ON-state,
perform second control to switch the second switch device to the ON-state after the first control, and
perform third control to switch the third switch device to the OFF-state after the second control.

8. The power conversion circuit according to claim 7,
wherein the control circuitry is configured to perform the third control in a state in which a current flows from the second terminal to the first terminal of the primary winding.

9. The power conversion circuit according to claim 3,
wherein, when an initial state is a state in which both the third switch device and the fourth switch device are in an ON-state, both the first switch device and the second switch device are in an OFF-state, and a current flows from the second terminal to the tap of the primary winding,
the control circuitry is configured to:
in a period in which a current flows from the second terminal side to the first terminal side of the primary winding,
perform first control to switch, from the initial state, the third switch device to the OFF-state and the second switch device to the ON-state,
perform second control to switch the first switch device to the ON-state after the first control, and
perform third control to switch the fourth switch device to the OFF-state after the second control.

10. The power conversion circuit according to claim 9,
wherein the control circuitry is configured to perform the third control in a state in which a current flows from the first terminal to the second terminal of the primary winding.

11. The power conversion circuit according to claim 1,
wherein the first bidirectional includes a first switch device and a second switch device, the first switch device having a drain terminal connected to the input terminal, the second switch device having a drain terminal connected to the first terminal of the primary winding and having a source terminal connected to a source terminal of the first switch device,
wherein the second bidirectional switch includes a third switch device and a fourth switch device, the third switch device having a drain terminal connected to the input terminal, the fourth switch device having a drain terminal connected to the tap of the primary winding and having a source terminal connected to a source terminal of the third switch device,
wherein the first switch device, the second switch device, the third switch device, and the fourth switch device are transistors configured to allow a current flow in a forward direction and a reverse direction, and
wherein the control circuitry is configured to control the first bidirectional switch by performing ON/OFF control on the first switch device and the second switch device, and control the second bidirectional switch by performing control on the third switch device and the fourth switch device.

12. A method for controlling a power conversion circuit including a transformer having a primary winding with a tap, a first bidirectional switch coupled between an input node and a first terminal of the primary winding, and a second bidirectional switch coupled between the input node and the tap, the method comprising:
supplying power to the input node;
monitoring a voltage applied to the primary winding or a current flowing through the primary winding; and
switching between a first state in which the first bidirectional switch is ON and the second bidirectional switch is OFF, and a second state in which the first bidirectional switch is OFF and the second bidirectional switch is ON,
wherein performing the switching includes switching during a period in which an absolute value of the voltage applied to the primary winding is below a threshold or during a period in which the current flowing through the primary winding is below a current threshold.

13. The method according to claim 12, wherein switching includes zero voltage switching (ZVS) performed when the voltage applied to the primary winding is substantially zero.

14. The method according to claim 12, wherein switching includes zero current switching (ZCS) performed when the current flowing through the primary winding is substantially zero.

15. The method according to claim 12, further comprising:
detecting a direction of the current flowing through the primary winding; and
selecting a switching pattern for switch devices within the first bidirectional switch and the second bidirectional switch based on the detected direction.

16. A power conversion system comprising:
a first converter; and
a second converter coupled to the first converter, the second converter including:
a transformer having a primary winding and a secondary winding, the primary winding having a tap,
a first bidirectional switch coupled to a first terminal of the primary winding, and
a second bidirectional switch coupled to the tap of the primary winding; and
control circuitry configured to selectively activate the first bidirectional switch or the second bidirectional switch to change an effective number of turns of the primary winding based on a voltage of the power output from the first converter.

17. The power conversion system according to claim 16, wherein the first converter is a matrix converter including a plurality of bidirectional switches.

18. The power conversion system according to claim 16, further comprising a rectifier circuit coupled to the secondary winding of the transformer.

19. The power conversion system according to claim 16, further comprising a low-pass filter coupled to an input of the first converter.
